(19) United States
(12) Patent Application Publication
(10) Pub. No.: US 2016/0079822 A1
(43) Pub. Date: Mar. 17, 2016

(54) ELECTRIC FLUID PUMP

(71) Applicant: HITACH AUTOMOTIVE SYSTEMS, LTD., Hitachinaka-shi (JP)

(72) Inventor: Kunito NOGUCHI, Isesaki-shi (JP)

(73) Assignee: HITACH AUTOMOTIVE SYSTEMS, LTD., Hitachinaka-shi (JP)

(21) Appl. No.: 14/845,470

(22) Filed: Sep. 4, 2015

(30) Foreign Application Priority Data
Sep. 11, 2014 (JP) 2014-185237

(51) Int. Cl. H02K 3/38; F04D 29/18; F04D 13/06

(52) U.S. Cl. CPC H02K 3/38; F04D 13/06; F04D 29/18; H02K 2203/06

(57) ABSTRACT

An electric fluid pump includes at least one crossover guide including a guide groove to guide a takeout wire segment of a winding wire defining windings, to a connection terminal located on a radial inner side of the guide groove. The guide groove of the crossover guide includes a takeout groove segment extending in a direction decreasing a radial distance from a center axis of the stator gradually and thereby holding the takeout wire segment of one phase on a radial inner side of crossover wire segments of the other phases.

### BACKGROUND OF THE INVENTION

The present invention relates to an electric fluid pump, and specifically to an electric fluid pump having a connection terminal provided in an electric motor section.

With an increase in the demand for lower fuel consumption of a vehicle, the practical realization of vehicles with an idle stop function and hybrid vehicles is advancing recently. In these vehicles, an engine-driven fluid pump is stopped at the time of stoppage of the internal combustion engine. Therefore, a driving source for driving a fluid pump is required, other than the engine. Furthermore, hybrid vehicles and electric vehicles require a cooling water pump for cooling a vehicle driving motor, its control apparatus or a battery. In view of such a background, the use is increasing, of an electric fluid pump performing a pumping action by rotating a rotor connected, by an impeller with the use of an electric motor.

The electric fluid motor normally employs an inner rotor type dc motor including a rotor provided with permanent magnet(s) and a stator surrounding the rotor and including three phase windings. In this inner rotor type dc motor, a winding wiring of each phase is made up of a plurality of windings wound around a plurality of salient poles and supplied with driving current sequentially to produce field. Therefore, the windings of each phase are connected by crossover wire(s).

In the inner rotor type dc motor, a winding wire of each phase is wound around salient poles to form windings, taken out from the windings, and drawn around to a position for electrical connection or to a connection terminal. Fusing process is known as a method for connecting or joining the winding wire with the connection terminal. The fusing process (or thermal caulking) is an electrical connecting process including an operation of setting a coated wire or cable in a connecting portion shaped to hold or clamp the coated wire, or in a U shaped groove defined by the connecting portion, and an operation of electrically connecting the conductor of the coated wire and the connecting portion or connecting terminal by supplying electric current to the coated wire held by the connecting portion while applying a pressure, to fuse and remove the coating of the coated wire with heat generated by the current and to join the conductor of the coated wire and the connecting portion or connection terminal by solid phase bonding with heat and pressure.

The fusing process is superior in productivity and reliable for producing reliable electrical connection. However, the fusing process requires an operation of inserting a special pressurizing electrode from the outside until contact with the connection terminal. Therefore, the operation is difficult on the inner side of the stator. This tendency is increased specifically in small sized dc motor. Furthermore, the arrangement in which the connecting portion for clamping a winding wire is formed to face radially inwards toward the center axis of the stator is disadvantageous because of the possibility of interference with a nozzle of a winding machine. Therefore, there is a demand for a structure facilitating the connection of a winding wire of the stator with a connection terminal.

JP2013-21824A (Patent Document 1) shows a structure to meet the above-mentioned demand. This structure includes an annular insulating base member mounted on a stator core and a connection terminal disposed on the insulating base member and connected with a winding wire forming a plurality of windings wound on salient poles of the stator core. The wire is taken out in the state in which the wire is exposed to the outside of the insulating base member and joined with the connection terminal, to facilitate the fusing process.

Patent Document 1: JP2013-21824A

### SUMMARY OF THE INVENTION

In the case of the fusing operation performed on the outer side of the stator, to avoid interference between a terminal wire segment of a winding wire to be connected with a connection terminal and crossover wires of the other phases, the connection terminal is positioned on the outer side of a crossover guide for holding the crossover wires, as mentioned in Patent Document 1. Therefore, the size of the dc motor is increased in the radial direction by the connection terminals formed on the outer side of the crossover guides.

It is an object of the present invention to provide an electric fluid pump adequate for facilitating the fusing process and preventing a size increase of the electric motor in the radial direction.

According to one aspect of the present invention, a connection terminal conne terminal wire segment of a winding wire is positioned on a radial inner side of a guide groove of a crossover guide, and the guide groove of the crossover guide is shaped to extend circumferentially in such a direction that a radial distance is decreased gradually and thereby to set the takeout terminal wire segment of one phase on the radial inner side of crossover wire segments of the other phases.

The connection terminal may include a connection portion projecting radially outward and having a shape adapted to clamp the takeout terminal wire segment on the radial outer side of the connection terminal.

### BRIEF DESCRIPTION OF THE DRAWINGS

FIG. 1 is a perspective view showing an electric fluid pump according to one embodiment of the present invention.

FIG. 2 is a perspective view showing the electric fluid pump of FIG. 1 in the state in which a cover is removed.

FIG. 3 is a perspective view showing a motor section taken out from the electric fluid pump shown in FIG. 2.

FIG. 4 is a perspective view showing the motor section of FIG. 3 in the state in which a control board is removed.

FIG. 5 is a longitudinal sectional view of the electric fluid pump of FIG. 1.

FIG. 6 is a perspective view showing a stator of motor section of FIG. 4 in the state in which a holder is removed, and crossover wires are omitted.

FIG. 7 is a front view of a portion including a connection terminal and a crossover guide in the stator of FIG. 6.

FIG. 8 is a top view of the portion shown in FIG. 7.

FIG. 9 is a perspective view of the portion shown in FIG. 7, as viewed obliquely from above.

### DETAILED DESCRIPTION OF THE PREFERRED EMBODIMENT(S)

An embodiment according to the present invention is explained with reference to the drawings hereinafter. However, the present invention is not limited to the illustrated embodiment(s). Various variation examples and application examples are included in the purview of the present invention.

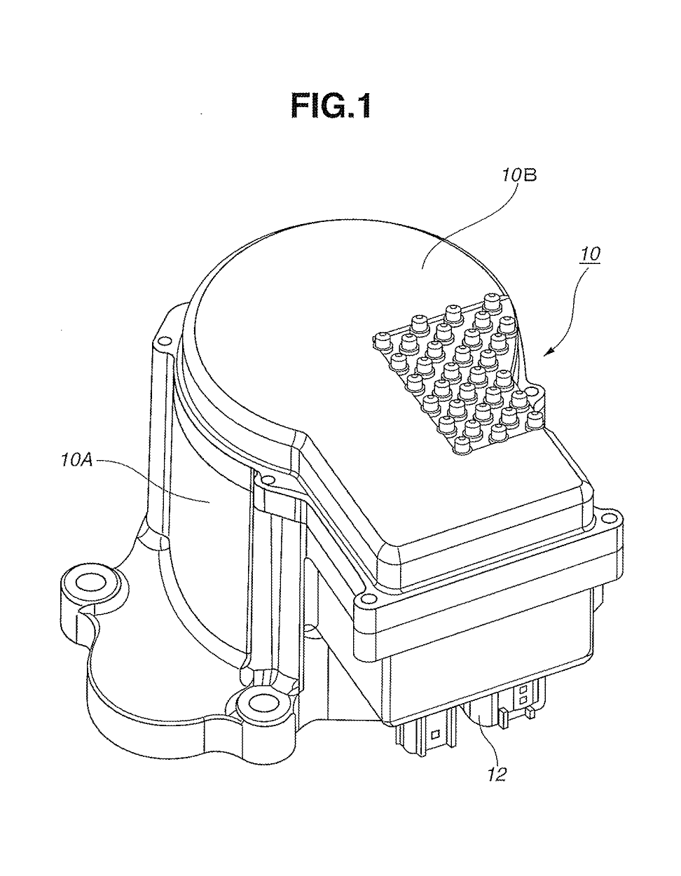

FIG. 1 shows an electric fluid pump according to one embodiment of the present invention in perspective. An electric fluid pump 10 includes a main body or main member 10A of material such as aluminum alloy, and a cover 10B made of metallic material such as aluminum alloy and fixed to main body 10A to cover a drive control section. This electric fluid pump is adapted to be fixed to a pump housing (not shown) and to perform a pumping action by rotating an impeller connected with a forward end of a rotation shaft. A connector 12 is taken out from main body 10A, and arranged to receive the supply of electric power from a battery (not shown). The cover 10B is made of metallic material and arranged to serve as a heat sink for dissipating heat produced in the drive control section, to the outside.

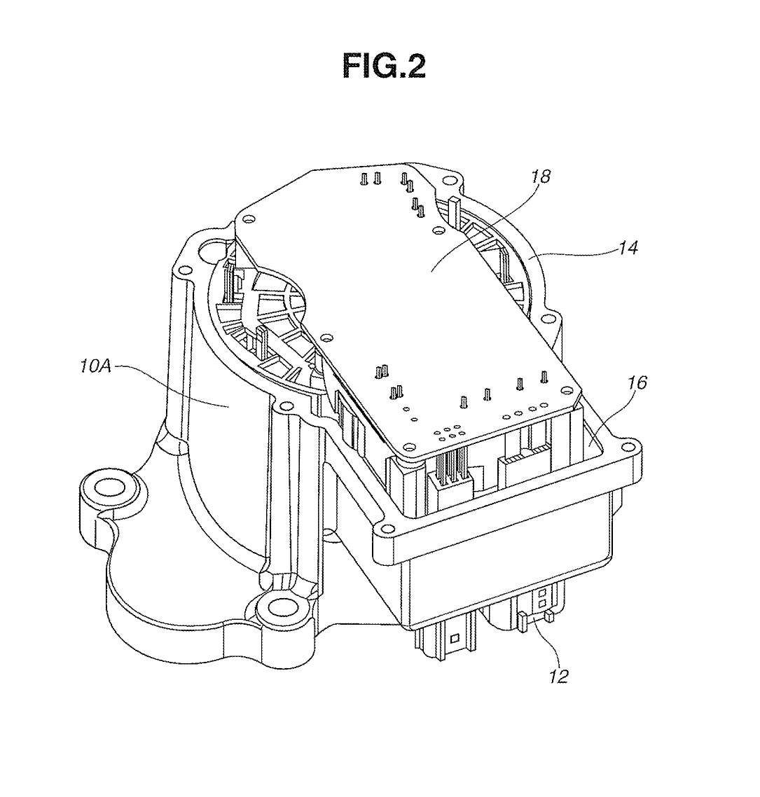

FIG. 2 shows, in perspective, the electric fluid pump 10 in the state in which cover 10B is removed. A motor section (not shown in FIG. 2) is installed in main body 10A. A holder 14 is a hollow cylindrical member of synthetic resin, attached so as to cover the motor section. A receiving portion 16 is provided in main member 10A. Receiving portion 16 is a box-shaped portion connected with a part of the outer circumference of holder 14. In this receiving portion 16, there are disposed later-mentioned electric components and the above-mentioned connector 12. A control board 18 is disposed and fixed on holder 14. A drive control circuit is attached between holder 14 and control board 18. This drive control circuit includes a circuit required to perform an inverter control of the motor section.

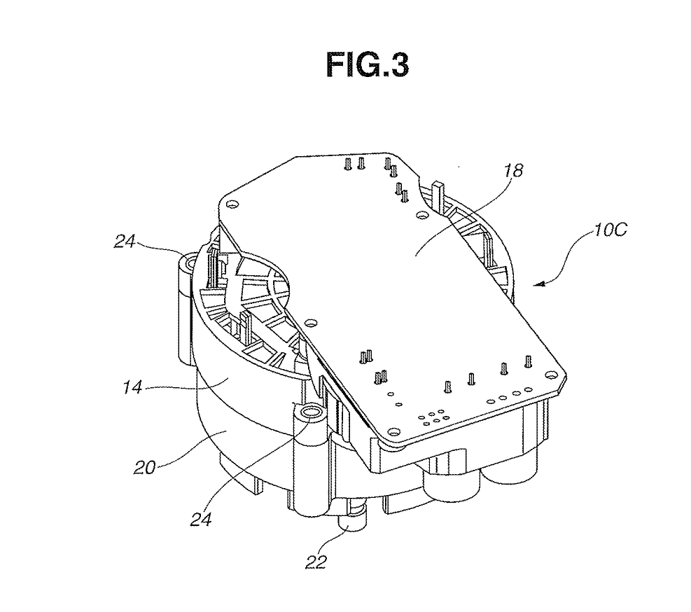

FIG. 3 shows the motor section 10C in perspective, in the state in which motor section 10 is taken out from main body 10A. The motor section 10C includes a stator section 20 and a rotor section (not shown in FIG. 3) disposed in the inside, and a rotation shaft 22 fixed with the rotor section. Holder 14 is fixed, by bolts 24, to the stator section 20.

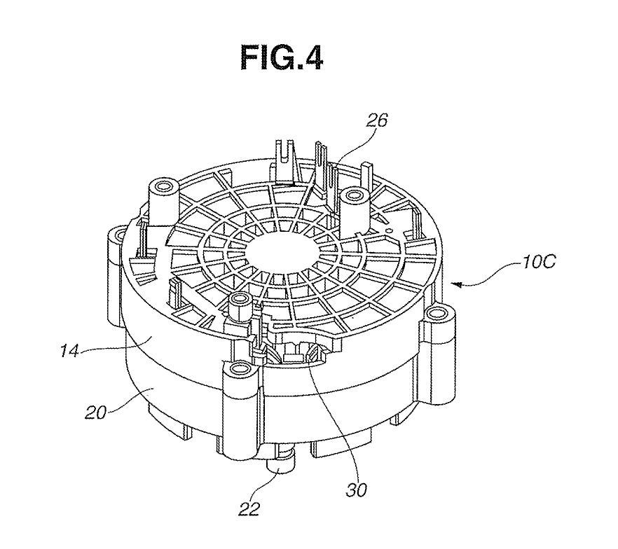

FIG. 4 shows, in perspective, the motor section 10C in the state in which the control board 18 is removed from the motor section 10C. The holder 14 is provided with connection terminals 26 for electrical connection with control board 18 and winding(s) of stator section 20. Each of connection terminals 26 has a function of electrical connection for the control board 18 and the winding(s) of stator section 20. Each connection terminal 26 is connected with an input portion and a neutral portion of each phase.

A cutout opening portion 30 is formed in a part of holder 14, and arranged to receive part of the electrical components such as inductance device and capacitor. This cutout opening portion 30 is formed so as to confront the box-shaped receiving portion 16 shown in FIG. 2.

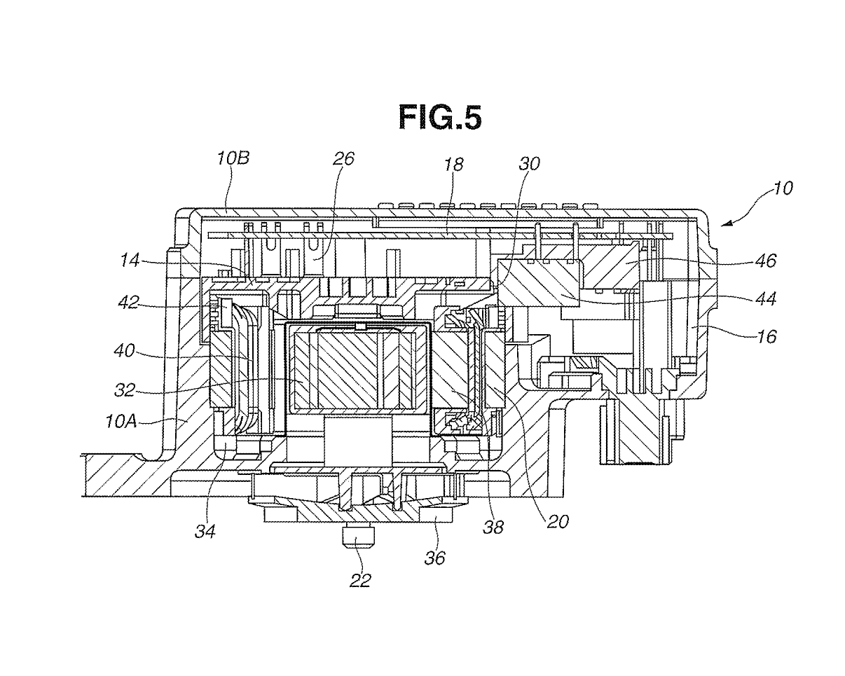

FIG. 5 shows the inner structure of the electric fluid pump 10. The motor section 10C includes at least the rotor section 32 and the stator section 20. Motor section 10C is disposed in a motor receiving portion 34 provided on one side of main body 10A of the metallic material such as aluminum alloy. Rotor section 32 is disposed in, and surrounded by stator section 20, and provided with permanent magnet(s). Therefore, the rotor section 32 receives a rotational force by the field produced by winding sections 40 of stator section 20.

The side of main body 10A opposite to this motor receiving portion 34 is formed to have a structure to be fixed to the pump housing (not shown). In this portion, the impeller 36 is disposed and arranged to be rotated by the rotation shaft 22, for performing the pumping action. Rotation shaft 22 is fixed with the rotor 32 of motor section 10C and driven by the rotation of rotor section 32.

The boundary between the motor receiving portion 34 and impeller 36 are sealed liquid tightly to prevent liquid from entering this portion. The stator section 20 disposed in the motor receiving portion 34 includes an iron core 38, the winding sections 40 each wound around a salient pole (not shown) of the iron core, and crossover guide(s) 42 each formed with a crossover groove to guide and retain a crossover wire or jumper wire for connecting the winding sections 40 of the same phase, as explained more in detail later.

Each crossover guide 42 is formed to stand between two of the salient poles. There are further provided crossover guides 42 formed behind each salient pole. The crossover guides are arranged to guide crossover wire(s) or jumper wire(s).

Stator 42 is covered fixedly by holder 14. Control board 18 is fixed in the state in which stator 42 and holder 14 are fixed together. As mentioned above, the circuit required for the inverter control is formed on and/or in the control board 18, and connected with the winding sections 40 through the connection terminals 26. Electric components such as inductor 44 and capacitor 46 are mounted on control board 18 near the end of control board 18. One or more large-sized components among these electric components are received in the receiving portion 16.

In the case of fusing operation on the outer side of the stator, in order to avoid interference between the end of winding to be connected with a connection terminal and the crossover wire of another phase, it is necessary to dispose the connection terminal on the outer side of the crossover guide holding the crossover wire, as explained in Patent Document 1. Therefore, the size of the dc motor is increased in the radial direction by the amount required to dispose the connection terminal on the outer side of the crossover guide.

Therefore, the connection structure according to this embodiment comprises a connection terminal which is to be connected with a takeout wire segment or terminal wire segment of a winding wire, and which is formed with a connecting portion formed on the (radial outer) side opposite to the (radial inner) side on which the bobbins are located and adapted to hold the takeout wire segment, and a crossover guide including a guide groove which is arranged to guide the takeout wire segment toward the connecting portion of the connection terminal located on the radial inner side of the guide groove, and which is extended circumferentially in a (slanting, inclined or spiral) direction toward the connection portion located on the radial inner side of the guide groove. Thus, the takeout wire segment of one phase is taken out from the radial inner side of crossover wires of the other phases.

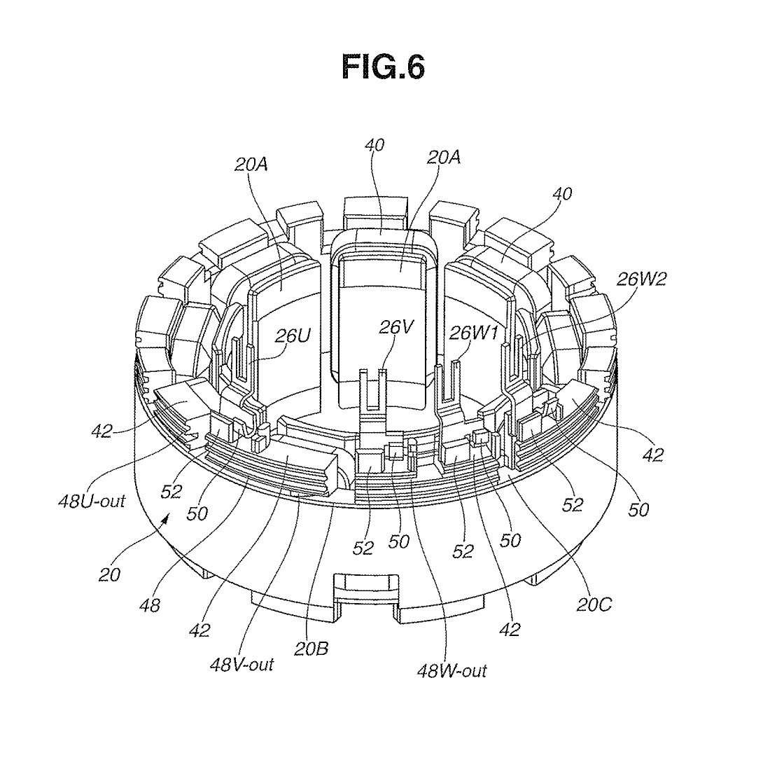

The detailed structure of stator section 20 of electric motor section 10C according to the embodiment is shown in FIGS. 5 and 6. In the example of FIGS. 5 and 6, the iron core 38 of stator section 20 is made of material such as laminated silicon steel sheet, and formed to have nine salient poles projecting radially inwards. Iron core 38 is a single unit core formed integrally with the salient poles. A bobbin portion 20A of insulating resin is provided around each salient pole, and arranged to have a function of insulating the salient pole from the winding wound around itself. A wire is wound around each bobbin portion 20A to form a winding section 40 of each phase.

The nine salient poles are arranged side by side and an insulating base 20B is formed on an inner circumferential side of the bobbin portions 20A and iron core 38. Bobbin portions 20A and insulating base 20B are integral parts of a single unit formed integrally by injection of an insulating synthetic resin. Insulating base 20B projects by a predetermined length in the axial direction of iron core 38, and includes an insulating surface 20C which is a substantially flat surface extending in the radial direction.

The crossover guides 42 are formed integrally on the insulting surface 20C so as to stand at positions between the bobbin portions 20A, and arranged to guide crossover wires connecting winding sections 40 of the same phase. Crossover guides 42 are arranged in the circumferential direction on the insulting surface 20C, respectively, at circumferential positions each between two adjacent winding sections 40. Moreover, crossover guides 42 for guiding crossover wires are further formed behind winding sections 40 projecting axially from the insulating surface 20C. Each of these crossover guides 42 includes an outer circumferential wall formed with crossover guide groove(s) 48 for guiding and holding crossover wire(s). Each crossover wire extends between the winding sections 40 of the same phase. The crossover wires are omitted in FIG. 6.

Each of bobbin portions 20A covers one of the salient poles, and supports the winding wound on the bobbin portion, thereby forming one of the winging sections 40. Bobbin portions 20A are arranged in the order of U phase, V phase and W phase, normally. In this practical example, a wire of each phase is wound in the form of three windings. Therefore, nine of the bobbin portions 20A are formed on the iron core 38. Specifically, there are formed a first set including a first U phase bobbin portion, a first V phase bobbin portion and a first W phase bobbin portion; a second set including a second U phase bobbin portion, a second V phase bobbin portion and a second W phase bobbin portion; and a third set including a third U phase bobbin portion, a third V phase bobbin portion and a third W phase bobbin portion. These bobbin portions are arranged in the order of the sets.

For each of the U, V and W phases, the wire starts from a starting end wire segment, extends windingly around the first, second and third bobbin portions through crossover wire(s) and terminates at a takeout end wire segment which is drawn out from the third bobbin portion and which is connected with the connection terminal of the corresponding phase.

In the example of FIG. 6, the wire wound around the third U phase bobbin portion is taken out from the adjacent crossover guide 42 and connected with the U phase connection terminal 26U. Similarly, the wire wound around the third V phase bobbin portion is taken out from the adjacent crossover guide 42 and connected with the V phase connection terminal 26V. The wire wound around the third W phase bobbin portion is taken out from the adjacent crossover guide 42 and connected with the W phase connection terminals 26W1 and 26W2. In this example, the two W phase terminals 26W1 and 26W2 are provided for the delta connection. However, the present embodiment is also applicable to the wye or star configuration.

As shown in FIGS. 5 and 6, the connection terminals 26U, 26V, 26W1 and 26W2 are located on the radial inner side of the crossover guide grooves 48 of crossover guides 42, on the side closer to the stator bobbin portions 20A. Each of the connection terminals 26U, 26V, 26W1 and 26W2 includes a connection or connecting portion 50 to be connected with the takeout end wire segment of the winding wire. The connection portions 50 of connection terminals 26U, 26V, 26W1 and 26W2 are formed on the outer radial side opposite to the inner radial side on which the bobbin portions 20A in the stator are located. The connection portions 50 are shaped in the form to clamp the takeout end wire segment or to hold the takeout end wire segment in a recess or groove, as explained more in detail later. The takeout end wire segment of each wire is held in the recess of the connection portion of the corresponding connection terminal. By applying pressure in this state, and supplying current to each of connection terminals 26U, 26V, 26W1 and 26W2 to generate heat, the coating of the wire is fused and removed, and the conductor of the wire is joined to form solid joint, for electrical connection, with the connection portion with heat and pressure.

The takeout end wire segment (40U-out) of the U phase winding to be connected with the U phase connection terminal 26U is received in a center crossover guide groove 48U among three crossover guide grooves 48 (48W, 48U, 48V) formed in the outer circumferential surface of crossover guide 42, and drawn out of the U phase crossover groove 48U from a takeout groove segment 48U-out of U phase crossover guide groove 48U. The takeout end wire segment of the V phase winding to be connected with the V phase connection terminal 26V is received in a lower crossover guide groove 48V formed at the lowermost position among the three crossover guide grooves 48U, 48V and 48W, and drawn out of the lower V phase crossover guide groove 48V from a takeout groove segment 48V-out of V phase crossover guide groove 48V. Similarly, the takeout end wire segment of the W phase winding to be connected with the W phase connection terminal is received in an upper crossover guide groove 48W formed at the uppermost position among the three crossover guide grooves 48U, 48V and 48W, and drawn out of the upper W phase crossover guide groove 48W from a takeout groove segment 48W-out of W phase crossover guide groove 48W.

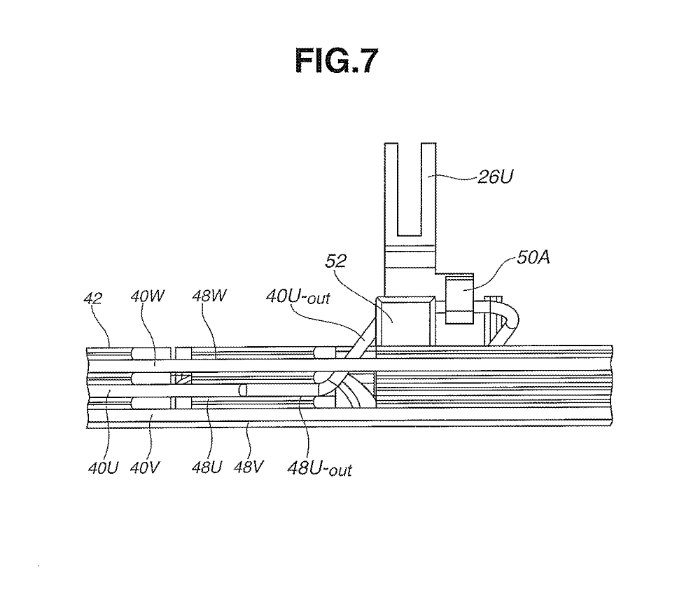

FIGS. 7, 8 and 9 are views for illustrating the detailed connecting structure of the crossover guides 42 and the connection terminals 26U, 26V, 26W1 and 26W2. In these figures, the connection structure of the U phase connection terminal 26U and the adjacent crossover guide 42 is taken as an example.

The crossover guide 42 is formed integrally with the insulating base member 20B so that the crossover guide 42 projects upright (in the axial direction) from the insulating surface 20C. The crossover guide grooves 48U, 48V and 48W are formed in the outer circumferential surface of crossover guide 42. In this example, these guide grooves are in the form of a groove recessed radially inwards and extended circumferentially. In this example, the W phase crossover guide groove 48W is located at the highest level, and the V phase crossover guide groove 48V is located at the lowest level. The U phase crossover guide groove 48U is located between the W phase guide groove 48W on the upper side and the V phase guide groove 48V on the lower side. The arrangement of these guide grooves is not limited to this example, and these guide grooves may be arranged in an order other than the order of guide groove 48W at the uppermost level, guide groove 48U at the center or middle level and guide groove 48V at the lowermost level.

Crossover wires 40U, 40V and 40W of the U, V and W phases are guided and held, respectively, in the U, V and W phase crossover guide grooves 48U, 48V and 48W. The takeout end wire segment 40U-out of U phase crossover wire 40U is taken out toward the U phase connection terminal 26U for connection with U phase connection terminal 26U. Similarly, the takeout end wire segment 40V-out (not shown) of V phase crossover wire 40V is taken out toward the V phase connection terminal 26V for connection with U phase connection terminal 26V. The takeout end wire segment 40W-out of W phase crossover wire 40W is taken out toward the W phase connection terminal 26W for connection with U phase connection terminal 26W.

The U phase connection terminal 26U stands upright from the insulating surface 20C of insulating base member 20B, at a radial inner position on the radial inner side of the outer circumferential surface of crossover guide 42. U phase connection terminal 26U includes an outer circumferential surface formed with a connection portion 50U which includes a holding portion 50A for holding or embracing the U phase takeout end wire segment 40U-out. This holding portion 50A is formed by cutting and bending from the U phase connection terminal 26U in the direction opposite to the bobbin 20A into a form defining a recess opening upwards and receiving the U phase takeout end wire segment 40U-out snugly.

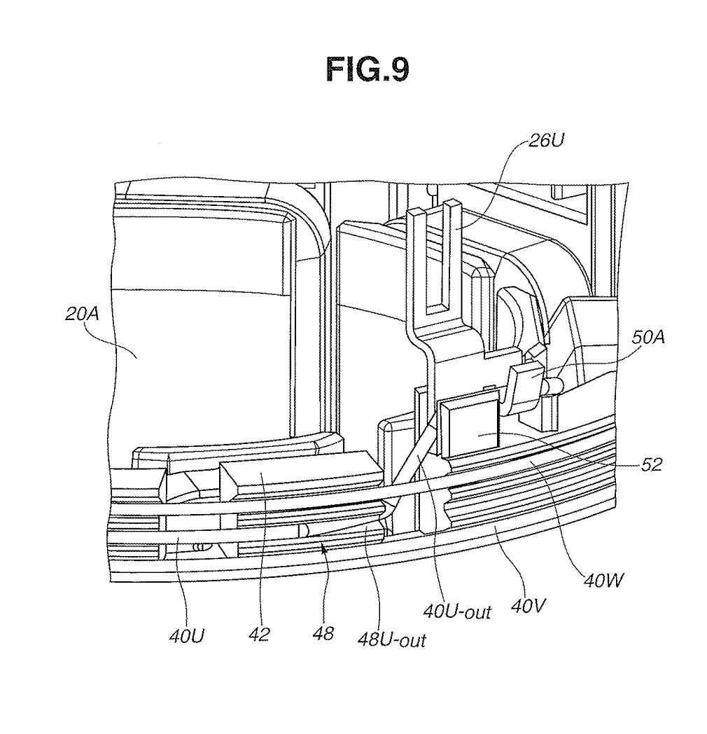

The U phase takeout end wire segment 40U-out is held by this holding portion 50A and subjected to the fusing operation. The holding portion 50A defines the recess opening upwards as shown in FIG. 9. The U phase takeout end wire segment 40U-out is inserted into this recess from above. In this state in which the U phase takeout end wire segment 40U-out is held in the recess of holding portion 50A, the fusing operation is performed by descending a pressurizing electrode of a fusing machine from above. This structure facilitate the fusing operation. Moreover, the holding portion 50A is formed in the outer side facing radially outwards. This structure eliminates the possibility of interference with a nozzle of a winding machine.

A takeout guide portion 52 is formed upright on the radial outer side of U phase connection terminal 26U. Takeout guide portion 52 stands upright and confronts the U phase connection terminal 26U. The U phase takeout end wire segment 40U-out is guided between the outer circumferential surface of U phase connection terminal 26U and the takeout guide portion 52. This takeout guide portion 52 functions to prevent the takeout end wire segment 40U-out from bulging outwards and contacting with the V phase crossover wire 40V and the W phase crossover wire 40W. Thus, with this takeout guide portion 52, the connecting structure can prevent short circuit due to vibrations causing contact of the takeout end wire segment 40U-out and another crossover wire, and damage of the coatings of the wires.

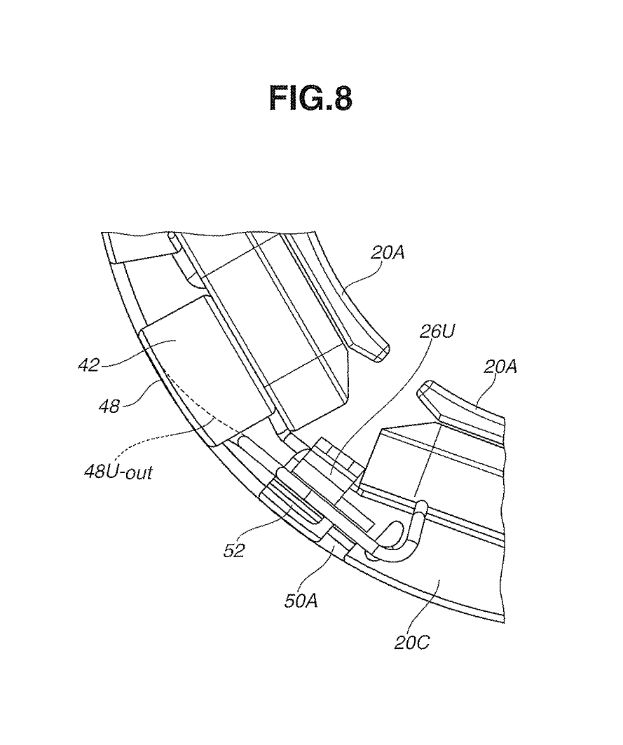

The crossover guide groove 48U formed at the middle level of crossover guide 42 includes a takeout groove segment 48U-out extending circumferentially in a slanting or spiraling direction decreasing a radial distance from the center axis of stator 20, as shown by a broken line in FIG. 8. In this example, the takeout groove segment 48U-out extends in the form of a curve (or spiral) that winds around the center axis at a continuously decreasing distance from the center axis. Takeout groove segment 48U-out terminates at a groove end located on the radial inner side of the position of the other crossover guide grooves 40V and 40W, at a position deeper and closer to the center axis than the position of the other crossover guide grooves 40V and 40W. The U phase takeout end wire segment 40U-out of the U phase winding is guided by the U phase takeout groove segment 48U-out extending in the direction decreasing the radial distance gradually. Therefore, the U phase takeout end wire segment 40U-out is taken out from the trailing end of the takeout groove segment 48U-out of U phase crossover guide groove 48U, at the inner position avoiding interference with the other crossover wires 40U and 40W. The U phase takeout groove segment 48U-out may be curved as shown in FIG. 8, or may be in a straight form extending rectilinearly in a slant straight line extending at a continuously decreasing radial distance from the center axis. The other crossover guide grooves are formed in the same manner to have a takeout groove segment.

Outside the takeout groove segment 48U-out, the U phase takeout wire segment 40U-out is guided between the outer side of the U phase connection terminal 26U and the takeout guide portion 52, and extended to the holding portion 50A of connection portion 50U of U phase connection terminal 26U. The U phase takeout end wire segment 40U-out is held by the holding portion 50A and subjected to the fusing operation.

Similarly, the V phase takeout end wire segment 40V-out is taken out through a takeout groove segment 48V-out (not shown) which is formed in the crossover guide groove 48V at the lowest level of crossover guide 42 and which extends circumferentially in a slanting or spiraling direction gradually decreasing the radial distance from the center axis of stator section 20. The V phase takeout groove segment 48V-out terminates at a groove end located on the radial inner side of the position of the other crossover guide grooves 40U and 40W, at a position deeper and closer to the center axis than the position of the other crossover guide grooves 40U and 40W. Similarly, the W phase takeout end wire segment 40W-out is taken out through a takeout groove segment 48W-out (not shown) which is formed in the crossover guide groove 48W at the highest level of crossover guide 42 and which extends circumferentially in a slanting or spiraling direction gradually decreasing the radial distance from the center axis of stator section 20. The W phase takeout groove segment 48W-out terminates at a groove end located on the radial inner side of the position of the other crossover guide grooves 40U and 40V, at a position deeper and closer to the center axis than the position of the other crossover guide grooves 40U and 40V.

Therefore, the V phase takeout end wire segment 40V-out and the W phase takeout end wire segment 40W-out are guided, respectively, by the V phase takeout groove segment 48V-out and W phase takeout groove segment 48W-out extending in the direction decreasing the radial distance gradually. Therefore, the V phase takeout wire segment 40V-out and W phase takeout wire segment 40W-out are taken out, respectively, from the trailing end of the takeout groove segment 48V-out and the trailing end of the takeout groove segment 48W-out, at the inner positions avoiding interference with the other crossover wires.

It is optional to employ a structure in which the takeout groove segment extending inwards toward the center of the stator is formed in all the guide grooves of all the crossover guide, instead of the structure in which at least one of the crossover guides includes first and second guide grooves having no takeout groove segment extending inward, and a third guide groove having a takeout groove segment extending inwards as in the illustrated embodiment.

In this embodiment, the connection terminals 26U, 26V, 26W1 and 26W2 are disposed in an imaginary circle so as to stand upright or axially on the insulating surface 20C of the insulating base member 20B. This arrangement facilitates the fusing process because fusing operations for the terminals can be performed smoothly by rotating the stator section 20. When the connection terminals 26U, 26Y, 26W1 and 26W2 are arranged circumferentially at regular intervals (equal angles), the fusing operations can be performed smoothly by rotating the stator section by a constant angular amount each time, so that the productivity can be improved.

As explained above, according to the illustrated embodiment of the present invention, a connection terminal is formed with a connection portion on a radial outer side, and positioned at a radial inner position (which may lie on an imaginary smaller circle around a center), and a crossover guide is formed with a guide groove depressed (radially inwards) to receive a winding wire and extended from a radial outer position (which may lie on an imaginary lager circle around the center (concentric with the smaller circle) having a radius larger than the radius of the imaginary smaller circle), circumferentially to a radial inner position (along a line deviating inwards from the imaginary larger circle) toward the connection terminal located on the radial inner side (on the smaller circuit). An end of a winding wire of each phase is taken out, toward the connection terminal, from the radial inner position on the radial inner side of crossover wires of the other phases

This connecting structure can avoid interference of the winding wire taken out to the connection terminal with winding wires of the other phases extending circumferentially (along an arc of the imaginary larger circle), and help reduce the radial dimension of the dc motor. Moreover, this structure facilitates the joining process by enabling a joining operation on the outer side of the connection terminal.

The present invention is not limited to the illustrated embodiment. Various modifications and variations are included in the present invention. For example, it is not necessary to include all the features of the illustrated practical example. Moreover, it is possible to replace a part of the structure of one practical example by a part of the structure of another practical example. Moreover, it is possible to add, to the structure of one practical example, a part of the structure of another practical example. Addition, deletion and/or replacement are possible among the practical examples.

In the illustrated example, the connection terminals 26U, 26V, 26W1 and 26W2 are located radially between the radial position of the crossover grooves 48 of crossover guides 42 and the radial position of the stator bobbin portions 20A. In the illustrated example, the connection portion (50, 50A) of the connection terminal is located at a higher position higher (in the axial direction) than the position of the guide groove(s). In the illustrated example, the takeout guide portion 52 is located at an intermediate position lower than the position of the connection portion (50, 50A), and higher than the position of the guide groove(s), as shown in FIG. 7 and FIG. 9.

In the illustrated example, the U, V or W phase crossover guide groove 48 near the corresponding connection terminal is a single continuous groove including a first or leading groove segment extending circumferentially at a substantially constant radial distance from the center axis of the stator section, and the takeout groove segment (48U-out) which is a second or trailing groove segment extending continuously from the end of the first groove segment, circumferentially at a continuously decreasing radial distance.

According to the illustrated embodiment of the present invention, an electric fluid pump comprises: a pump section, a motor section, and connection terminals. The pump section is a section to move a fluid. The motor section includes a rotor section and a stator section. The stator section includes a stator core including an outer core section surrounding the rotor section, and a plurality of salient poles projecting radially inwards toward a center (line) of the stator section, from the outer core section, and a winding circuit. The winding circuit of this embodiment includes a first phase wiring, a second phase wiring and a third phase wiring. The wiring of each of the first, second and third phases includes a plurality of winding sections each wound on one of the salient poles, at least one crossover or jumper wire segment connecting the winding sections and a takeout terminal wire segment connected with one of the connection terminals. The stator section further includes at least one crossover guide formed with a first guide groove, depressed radially inwards, for holding the crossover wire segment of the first phase, a second guide groove, depressed radially inwards, for holding the crossover wire segment of the second phase and a third guide groove, depressed radially inwards, for guiding the takeout terminal wire segment of the third phase. (In the illustrated example, the first, second and third guide grooves of the crossover guide extend side by side in the circumferential direction.) The third guide groove, depressed radially inwards, for guiding the takeout terminal wire segment includes a leading groove segment extending circumferentially from a leading groove end of the third guide groove, and a trailing groove segment extending circumferentially and continuously from an end of the leading groove segment to a trailing groove end of the third guide groove. The trailing groove segment extends around the center (line) of the stator section, at a radial distance from the center gradually decreasing to the trailing groove end of the third guide groove, and thereby holding the takeout wire segment of the third phase on a radial inner side of the crossover wire segments of the first and second phases which are held, respectively, by the first and second guide grooves of the crossover guide.

The stator section may further include an insulating covering section (14, 20A, 20B, 20C) covering the stator core. The connection terminals are supported by the insulating covering section, and the crossover guide(s) is supported by or formed in the insulating covering section. The insulating covering section may be arranged to support a control board to control the motor section. The connection terminal of each phase may include a base portion projecting axially and a connection portion formed on a radial outer side of the base portion. The connection terminal of each phase (or the base portion of the connection terminal of each phase) is located on a radial inner side of the guide grooves of the crossover guide.

1. An electric fluid pump comprising:
a pump section;
a motor section including,
a rotor section and
a stator section including,
a plurality of U phase winding sections each wound on a bobbin,
a plurality of V phase winding sections each wound on a bobbin,
a plurality of W phase winding sections each wound on a bobbin; and
connection terminals to supply drive signals to the winding sections to rotate the rotor section and thereby to drive the motor section;
the winding sections of each phase being connected by a crossover wire segment guided by a crossover guide formed in the stator section, and further connected with one of the connection terminals through a takeout wire segment connected with a connection portion of the connection terminal;
the connection portion of the connection terminal of each phase being formed on a side opposite to a side on which the bobbins of the stator section are located,
at least one of the crossover guides including a guide groove which is arranged to guide the takeout wire segment of one of three phases toward the connection portion of an adjacent one of the connection terminals located on a radial inner side of the guide groove, and which includes a takeout groove segment extending in a direction decreasing a radial distance gradually and thereby holding the takeout wire segment on a radial inner side of the crossover wire segments of the other phases.

2. The electric fluid pump as claimed in claim 1, wherein the connection terminals of the three phases are arranged in a circle on the stator section and the guide grooves of the crossover guides for holding the crossover wires are arranged in a circle having a radius greater than a radius of the circle on which the connection terminals are arranged.

3. The electric fluid pump as claimed in claim 1, wherein the takeout groove segment of the guide groove of the crossover guide of one phase extends circumferentially toward the connection terminal of the phase along a curved or straight line decreasing a radial distance from a center of the stator section.

4. The electric fluid pump as claimed in claim 1, wherein each of the connection terminals includes a portion which is cut and raised to an outer side opposite to the side on which the bobbins are located, and which is arranged to clamp the takeout wire segment to facilitate a fusing operation to join the takeout wire segment with the connection terminal.

5. The electric fluid pump as claimed in claim 1, wherein a takeout guide portion is formed on an outer side of the connection terminal of each phase, and arranged to guide the takeout wire segment to the connection portion through an interspace between the takeout guide portion and the connection terminal confronting each other across the interspace.

6. The electric fluid pump as claimed in claim 1, wherein the stator section includes a first crossover guide which is one of the crossover guides, the first crossover guide being formed with a first guide groove, extended circumferentially and depressed radially inwards, for holding the crossover wire segment of a first phase which is a first one of U, V and W phases, a second guide groove, extended circumferentially and depressed radially inwards, for holding the crossover wire segment of a second phase which is a second one of the U, V and W phases, and a third guide groove, extended circumferentially and depressed radially inwards, for guiding the takeout wire segment of a third phase which is a third one of the U, V and W phases, the third guide groove being a single continuous groove extending circumferentially from a leading groove end through an intermediate point to a trailing groove end, and including a leading groove segment extending circumferentially from the leading groove end to the intermediate point, and a trailing groove segment serving as the takeout groove segment and extending circumferentially from the intermediate point to the trailing groove end, the trailing groove segment extending from the intermediate position to a radial inner position circumferentially around a center of the stator section, at a decreasing radial distance from the center of the stator section gradually decreasing to the trailing groove end of the third guide groove.
